(19) United States
(12) Patent Application Publication
(10) Pub. No.: US 2026/0291861 A1
(43) Pub. Date: Sep. 24, 2026

(54) FAST CONVERGENCE VIA STAGGERING EVPN MAC/IP WITHDRAWALS UPON ETHERNET SEGMENT FAILURE OF A PE

(71) Applicant: Cisco Technology, Inc., San Jose, CA (US)

(72) Inventors: Ali Sajassi, Alamo, CA (US); Krishnaswamy Muddenahally Ananthamurthy, Leander, TX (US); Mankamana Prasad Mishra, San Jose, CA (US); Chuanfa Wang, Kanata (CA)

(73) Assignee: Cisco Technology, Inc., San Jose, CA (US)

(21) Appl. No.: 19/288,518

(22) Filed: Aug. 1, 2025

Related U.S. Application Data
(60) Provisional application No. 63/773,940, filed on Mar. 18, 2025.

(51) Int. Cl. H04L 45/28; H04L 12/46; H04L 45/02

(52) U.S. Cl. CPC H04L 45/28; H04L 12/4641; H04L 45/04

(57) ABSTRACT

In one implementation, a device makes a determination that an interface associated with an Ethernet Segment of an Ethernet Virtual Private Network (EVPN) has failed. The device clears, based on the determination, a Media Access Control (MAC) address associated with the Ethernet Segment from a Layer-2 Routing Information Base (L2RIB) of the device. The device sets a random timer for the MAC address. The device sends a Border Gateway Protocol (BGP) MAC withdrawal message for the MAC address on expiration of the random timer.

### RELATED APPLICATIONS

This application claims priority to U.S. Provisional Application No. 63/773,940, filed Mar. 18, 2025 and entitled “FAST CONVERGENCE VIA STAGGERING EVPN MAC/IP WITHDRAWALS UPON ETHERNET SEGMENT FAILURE OF A PE” by Sajassi, et al., the contents of which are incorporated herein by reference.

### TECHNICAL FIELD

The present disclosure relates generally to computer networks and, more particularly, to fast convergence via staggering Ethernet Virtual Private Network (EVPN) Media Access Control (MAC)/Internet Protocol (IP) withdrawals upon Ethernet segment failure of a provider edge (PE).

### BACKGROUND

Ethernet Virtual Private Network (EVPN) is a networking technology that allows Wide Area Network (WAN) protocols to carry Layer-2 Ethernet traffic between remote devices as part of a virtual private network (VPN). Typically, an EVPN includes any number of customer edge (CE) devices (e.g., hosts, routers, etc.) connected to provider edge (PE) routers of a core network.

Currently, when an interface failure occurs in an EVPN that uses all-active, multi-homing and results in an Ethernet Segment(ES) failure on the corresponding PE router, all MAC addresses learned from that ES are withdrawn simultaneously. This results in a storm of Border Gateway Protocol (BGP) withdrawal messages which can cause processing delays and slower network convergence on the remote PE devices.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example Ethernet Virtual Private Network (EVPN) deployment; and

FIG. 4 illustrates an example procedure for staggering Media Access Control (MAC)/Internet Protocol (IP) withdrawals upon Ethernet Segment(ES) failure of a provider edge (PE).

### DESCRIPTION OF EXAMPLE IMPLEMENTATIONS

### Overview

According to one or more implementations of the disclosure, a device makes a determination that an interface associated with an Ethernet Segment of an Ethernet Virtual Private Network (EVPN) has failed. The device clears, based on the determination, a Media Access Control (MAC) address associated with the Ethernet Segment from a Layer-2 Routing Information Base (L2RIB) of the device. The device sets a random timer for the MAC address. The device sends a Border Gateway Protocol (BGP) MAC withdrawal message for the MAC address on expiration of the random timer.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P 1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

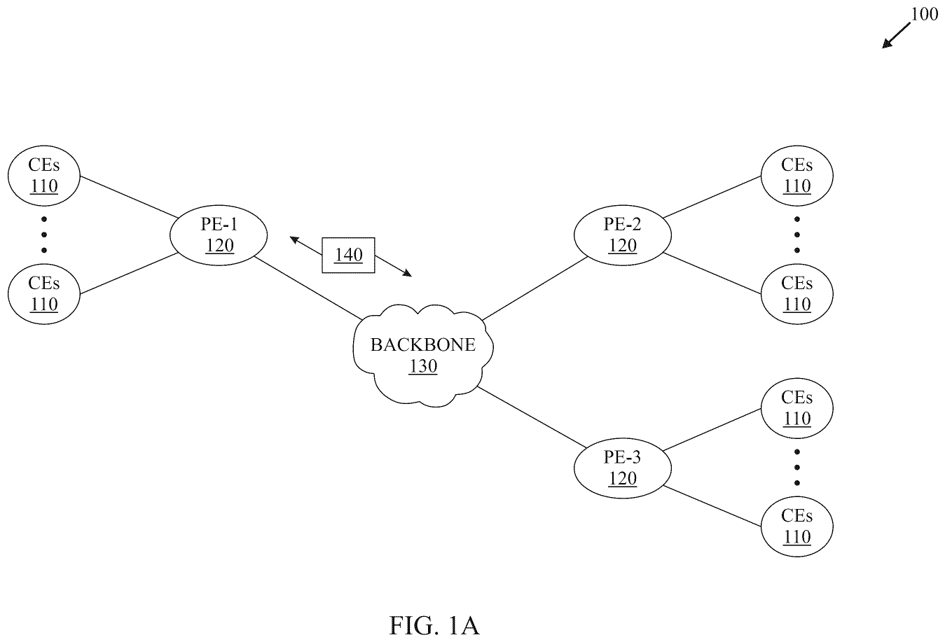

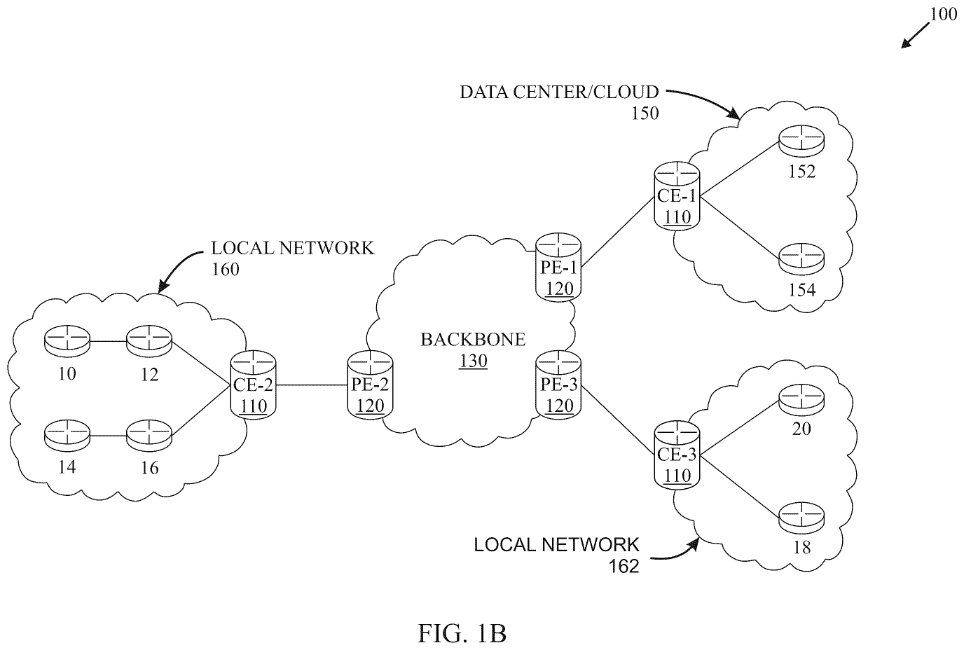

FIG. 1A is a schematic block diagram of an example of a computer network 100 illustratively comprising nodes/devices, such as a plurality of routers/devices interconnected by links or networks, as shown. For example, customer edge (CE) routers (e.g., CE routers 110) may be interconnected with provider edge (PE) routers (e.g., PE routers 120 PE-1, PE-2, and PE-3) in order to communicate across a core network, such as an illustrative network backbone (e.g., network backbone 130). For example, CE routers 110 and PE routers 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router (e.g., CE routers 110) shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router connected to PE-2 and a second CE router connected to PE-3.

FIG. 1B illustrates an example of computer network 100 in greater detail, according to various implementations. As shown, network backbone 130 may provide connectivity between devices located in different geographical areas and/or different types of local networks. For example, computer network 100 may comprise local/branch networks (local network 160, local network 162, etc.) that include devices/nodes 10-16 and devices/nodes 18-20, respectively, as well as a data center/cloud environment 150 that includes servers 152-154. Notably, local network 160, local network 162, and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

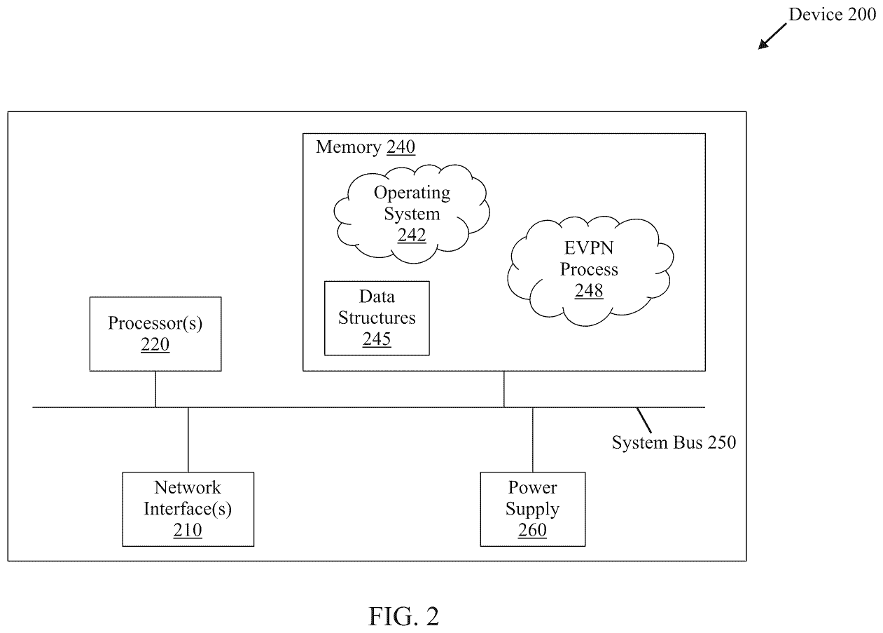

FIG. 2 is a schematic block diagram of an example device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces (e.g., network interfaces 210), a processor 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components and/or services may comprise an EVPN process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

EVPN process 248 may include computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database including, e.g., data used to make forwarding decisions. In particular, changes in the network topology may be communicated among routers using routing protocols, such as the OSPF and IS-IS link-state protocols (e.g., to “converge” to an identical view of the network topology).

Notably, EVPN process 248 may also perform functions related to virtual routing protocols, such as maintaining a virtual routing and forwarding (VRF) instance, or tunneling protocols, such as for Multiprotocol Label Switching (MPLS), Generalized MPLS (GMPLS), etc., each as will be understood by those skilled in the art. In various implementations, EVPN process 248 may also utilize EVPN, e.g., as described in the IETF Internet Draft entitled “BGP MPLS Based Ethernet VPN” <draft-ietf-l2vpn-evpn>, introduce a solution for multipoint L2VPN services, with advanced multi-homing capabilities, using BGP for distributing customer/client media access control (MAC) address reach-ability information over the core MPLS/IP network.

As noted above, when an interface failure occurs in an EVPN that uses all-active, multi-homing and results in an Ethernet Segment(ES) failure on the corresponding PE router, all MAC addresses learned from that ES are withdrawn simultaneously. This results in a storm of Border Gateway Protocol (BGP) withdrawal messages which can cause processing delays and slower network convergence on the remote PE devices.

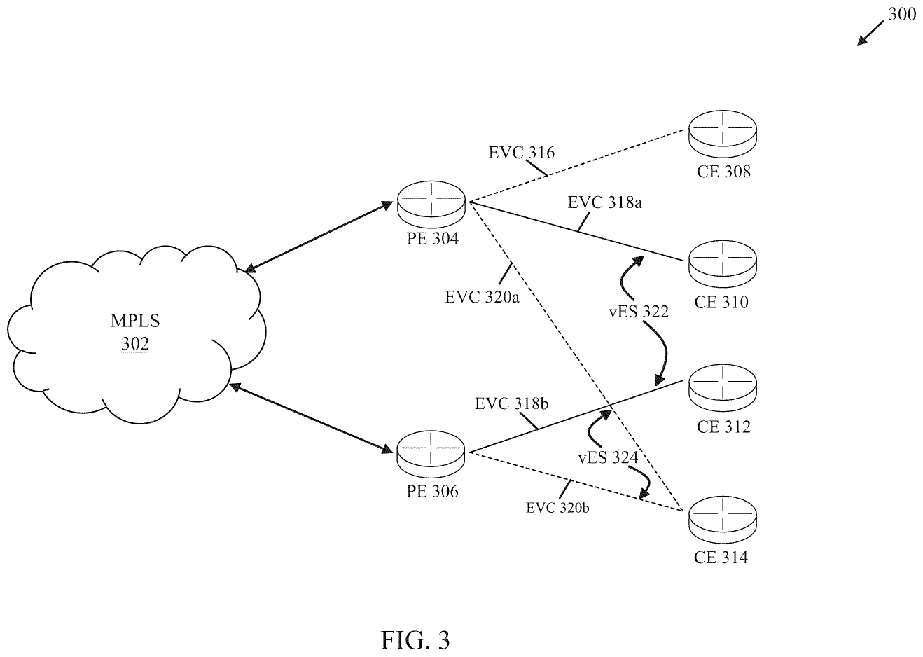

For example, FIG. 3 illustrates an example Ethernet Virtual Private Network (EVPN) deployment 300, in various implementations. As shown, deployment 300 may include any number of provider edge (PE) devices such as PE 304 and PE 306. In some implementations, these devices may communicate with each other over a Multi-Protocol Label Switching (MPLS) network 302. Deployment 300 may also include any number of customer edge (CE) devices (e.g., routers, switches, hosts, etc.), such as CE 308, CE 310, CE 312, and CE 314 shown. In some instances, PE 304 and PE 306 may provide virtual, Layer-2 bridged connectivity between CE 308, CE 310, CE 312, and CE 314.

In some instances, PE 304, PE 306, CE 308, CE 310, CE 312, and CE 314 may form an access network, which may take the form of an Ethernet Access Network (EAN), a MPLS network, or an IP network. PE 304 and PE 306 may provide connectivity to CE 308, CE 310, CE 312, and CE 314 via one or more ports, which may be a physical port or a logical port, such as a Network-to-Network (NNI). Each NNI may be associated with one or more Ethernet Virtual Circuits (EVCs) such as EVC 316, EVC 318a, EVC 318b, EVC 320a, and EVC 320b.

As would be appreciated, a Virtual Ethernet Segment (vES) can include multiple EVCs. For instance, EVC 318a and EVC 318b may form vES 322. Likewise, vES 324 may include EVC 320a and EVC 320b. By utilizing EVCs, a single NNI port on PE 304 or PE 306 may connect to multiple CE devices. In some implementations, a switch can be used to aggregate multiple EVCs into a single physical port on PE 304 or PE 306. For example, EVC 316, EVC 318a, and EVC 320a could be connected to a switch coupled to a port of PE 304.

Deployment 300 may leverage any suitable mechanism to provide multipoint Ethernet service, such as EVPN or provider backbone bridging EVPN (PBB-EVPN). In such cases, PE 304 and PE 306 can signal and learn MAC addresses of their corresponding CEs using the Border Gateway Protocol (BGP). This allows PE 304 and PE 306 to learn what CEs or networks are single-homed or multi-homed.

When a CE is multi-homed, that is, connected to more than one PE, there are typically two modes available to provide redundancy. In all-active redundancy mode, all of the PEs attached to a particular vES are allowed to forward traffic to/from that vES. In single-active redundancy mode, only a single PE (the designated forwarder), among a group of PEs attached to a vES, is allowed to forward traffic to/from the vES.

Turning back to deployment 300, it can include both single-homed and multi-homed CE devices and networks. For example, CE 308 is connected to PE 304 via EVC 316 and not connected to any other PE device. In such a case, CE 308 is considered single-homed. This means that if a failure associated with EVC 316 occurs, CE 308 will be left without any network connectivity because there are no other connections to a PE device to provide redundancy.

Conversely, CE 314 can be considered as multi-homed as because it has connections to both PE 304 and to PE 306 via EVC 320a and EVC 320b, respectively. In such a case, PE 304 and PE 306 can function together in either all-active redundancy mode or in single-active redundancy mode with respect to CE 314.

As mentioned above, each PE in a service provider network can advertise the MAC addresses and/or routes associated with each of its ports. Thus, PE 304 may advertise that vES 324 is associated with its interface/port. Likewise, PE 306 may advertise that vES 324 is associated with its interface/port.

Computer network 100 can also include multiple CE devices that are part of a single customer network, such as one that includes CE 310 and CE 312, thereby forming a multi-homed network. Doing so can increase the redundancy for the customer network, similar to a single, multi-homed device, by having PE 304 and PE 306 operate in single-active redundancy or all-active redundancy mode.

In the event a failure occurs at a PE device that is associated with a multi-homed CE device, the system has to converge efficiently, to minimize network down-time and avoid lost data packets. For example, PE 304 and PE 306 can operate in single-active redundancy mode with respect to CE 314 with PE 304 as the designated forward. If a port failure occurs at PE 304, it must alert PE 306 (as well as any other PEs in the network) of the failure such that PE 306 can commence routing network traffic to CE 314 as soon as possible.

However, the port/interface of PE 304 can be associated with upwards of thousands of Virtual Ethernet Segments. Currently, when an interface failure occurs in an EVPN that uses all-active, multi-homing and results in an Ethernet Segment(ES) failure on the corresponding PE router, all MAC addresses learned from that ES are withdrawn simultaneously. This results in a storm of Border Gateway Protocol (BGP) withdrawal messages which can cause processing delays and slower network convergence on the remote PE devices.

### Fast Convergence via Staggering EVPN MAC/IP Withdrawals Upon Ethernet Segment failure of a PE

The techniques herein prevent a storm of EVPN MAC/IP route withdrawals upon an ES failure by staggering their withdrawal messages. This results in the faster advertisement and processing of mass-withdraw messages and, thus, faster network convergence on all remote PEs.

Illustratively, the techniques described herein may be performed by hardware, software, and/or firmware, such as in accordance with EVPN process 248, which may include computer executable instructions executed by the processor 220 (or independent processor(s) of network interfaces 210) to perform functions relating to the techniques described herein.

Specifically, in various implementations, a device makes a determination that an interface associated with an Ethernet Segment of an Ethernet Virtual Private Network (EVPN) has failed. The device clears, based on the determination, a Media Access Control (MAC) address associated with the Ethernet Segment from a Layer-2 Routing Information Base (L2RIB) of the device. The device sets a random timer for the MAC address. The device sends a Border Gateway Protocol (BGP) MAC withdrawal message for the MAC address on expiration of the random timer.

Operationally, the techniques herein propose the following:
1. Upon detection of an interface failure, the MAC addresses in the bridge table of the EVPN are flushed. As would be appreciated, in EVPN, the bridge table is the MAC-VRF table that stores the MAC addresses and their corresponding VLANs.
2. This MAC address flushing in the bridge table (L2FIB) also results in deleting MAC address entries in the Layer 2 Routing Information Base (L2RIB).
3. If there is an IP address associated with a flushed MAC address, then the L2RIB informs an Address Resolution Protocol/Neighbor Discovery (ND) module to probe for that MAC if needed. If no response is received, then that entry is deleted a BGP module is asked to send a MAC+IP withdrawal message.
4. The L2RIB also informs the BGP module to send a MAC withdrawal message.
5. When a BGP module receives a MAC withdrawal or MAC+IP withdrawal message, it checks to see whether the Ethernet Segment Identifier (ESI) associated with the MAC address is active or not. If it is not active, then the BGP module sets a timer that is randomized between a certain time interval (e.g., between 0 and 5 minutes, etc.) for that MAC (or MAC+IP) entry.
6. Upon expiration of the timer, the BGP module only then sends a MAC (or MAC+IP) withdrawal message.

This approach ensures that MAC (or MAC+IP) withdrawal messages are staggered and without overwhelming the receiving PE. This results in faster processing of mass-withdraw messages and faster network convergence. In addition, the techniques herein advantageously can be implemented in existing networking devices by updating their BGP mechanisms through a localized software change.

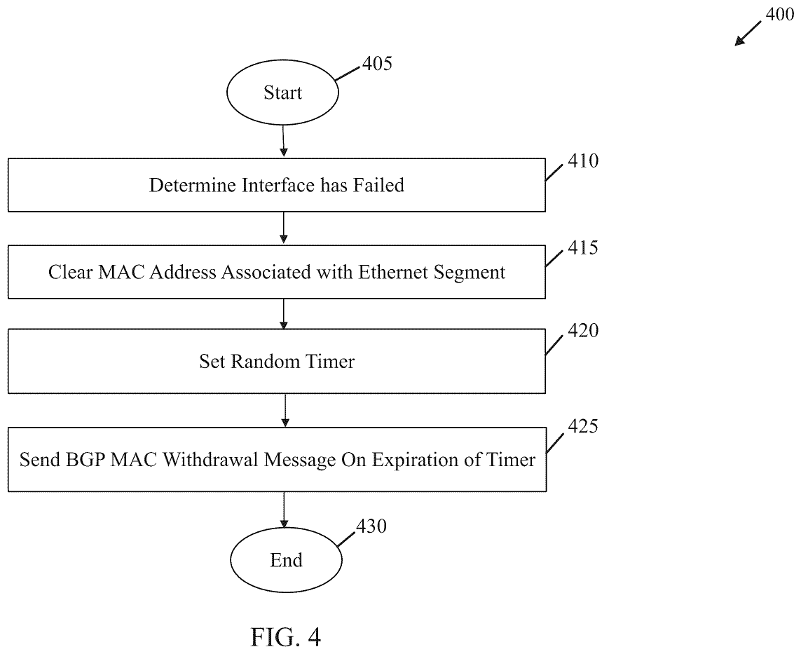

FIG. 4 illustrates an example procedure 400 (e.g., a method) for staggering Media Access Control (MAC)/Internet Protocol (IP) withdrawals upon Ethernet Segment(ES) failure of a provider edge (PE), in accordance with one or more implementations described herein. For example, a non-generic, specifically configured device (e.g., device 200, such as a router), may perform procedure 400 (e.g., a method) by executing stored instructions (e.g., EVPN process 248). The procedure 400 may start at step 405, and continues to step 410, where, as described in greater detail above, the device (e.g., a controller, processor, etc.) may make a determination that an interface associated with an Ethernet Segment of an Ethernet Virtual Private Network (EVPN) has failed.

At step 415, as detailed above, the device may clear, based on the determination, a Media Access Control (MAC) address associated with the Ethernet Segment from a Layer-2 Routing Information Base (L2RIB) of the device. In one implementation, the Ethernet Segment is one of a plurality of all-active, multi-homed EVPN Ethernet Segments associated with the device.

At step 420, the device may set a random timer for the MAC address, as described in greater detail above. In some implementations, the random timer randomly selects a time that is five minutes or less. In one implementation, the device sets the random timer based in part on an Ethernet Segment Identifier associated with the MAC address being active.

At step 425, as detailed above, the device may send a Border Gateway Protocol (BGP) MAC withdrawal message for the MAC address on expiration of the random timer. In some implementations, the MAC address is associated with an Internet Protocol (IP) address in the L2RIB. In such cases, the MAC withdrawal message may be a MAC and IP withdrawal message that also indicates the IP address associated with the MAC address. In various implementations, the MAC address is one of a plurality of MAC addresses to be withdrawn as a result of the determination and the device may stagger BGP MAC withdrawal messages for each of the plurality of MAC addresses by sending them at random times. For instance, the device may do so by setting random timers for each of the plurality of MAC addresses and sending a corresponding BGP MAC withdrawal message for one of the plurality of MAC addresses on expiration of its random timer. In one implementation, the device sends the BGP MAC withdrawal message to a provider edge (PE) router.

Procedure 400 then ends at step 430.

It should be noted that while certain steps within procedure 400 may be optional as described above, the steps shown in FIG. 4 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for fast network convergence via stagging EVPN MAC/IP withdrawals upon Ethernet Segment failure of a PE, it is to be understood that various other adaptations and modifications may be made within the spirit and scope of the implementations herein.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as tangible, non-transitory, computer-readable medium having computer-executable instructions stored thereon that, when executed by a processor on a computer, cause the computer to perform a method. For example, the components and/or elements may be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
making, by a device, a determination that an interface associated with an Ethernet Segment of an Ethernet Virtual Private Network (EVPN) has failed;
clearing, by the device and based on the determination, a Media Access Control (MAC) address associated with the Ethernet Segment from a Layer-2 Routing Information Base (L2RIB) of the device;
setting, by the device, a random timer for the MAC address; and
sending, by the device, a Border Gateway Protocol (BGP) MAC withdrawal message for the MAC address on expiration of the random timer.

2. The method as in claim 1, wherein the MAC address is associated with an Internet Protocol (IP) address in the L2RIB.

3. The method as in claim 2, wherein the MAC withdrawal message is a MAC and IP withdrawal message that also indicates the IP address associated with the MAC address.

4. The method as in claim 1, wherein the random timer randomly selects a time that is five minutes or less.

5. The method as in claim 1, wherein the MAC address is one of a plurality of MAC addresses to be withdrawn as a result of the determination, the method further comprising:
staggering, by the device, BGP MAC withdrawal messages for each of the plurality of MAC addresses by sending them at random times.

6. The method as in claim 5, wherein staggering the BGP MAC withdrawal messages comprises:
setting random timers for each of the plurality of MAC addresses; and
sending a corresponding BGP MAC withdrawal message for one of the plurality of MAC addresses on expiration of its random timer.

7. The method as in claim 1, wherein the device sends the BGP MAC withdrawal message to a provider edge (PE) router.

8. The method as in claim 1, wherein the device sets the random timer based in part on an Ethernet Segment Identifier associated with the MAC address being active.

9. The method as in claim 1, wherein the Ethernet Segment is one of a plurality of all-active, multi-homed EVPN Ethernet Segments associated with the device.

10. The method as in claim 1, wherein the device is a router.

11. An apparatus, comprising:
one or more network interfaces;
a processor coupled to the one or more network interfaces and configured to execute one or more processes; and
a memory configured to store a process that is executable by the processor, the process when executed configured to:
make a determination that an interface associated with an Ethernet Segment of an Ethernet Virtual Private Network (EVPN) has failed;
clear, based on the determination, a Media Access Control (MAC) address associated with the Ethernet Segment from a Layer-2 Routing Information Base (L2RIB) of the apparatus;
set a random timer for the MAC address; and
send a Border Gateway Protocol (BGP) MAC withdrawal message for the MAC address on expiration of the random timer.

12. The apparatus as in claim 11, wherein the MAC address is associated with an Internet Protocol (IP) address in the L2RIB.

13. The apparatus as in claim 12, wherein the MAC withdrawal message is a MAC and IP withdrawal message that also indicates the IP address associated with the MAC address.

14. The apparatus as in claim 11, wherein the random timer randomly selects a time that is five minutes or less.

15. The apparatus as in claim 11, wherein the MAC address is one of a plurality of MAC addresses to be withdrawn as a result of the determination, the process when executed being further configured to:
stagger BGP MAC withdrawal messages for each of the plurality of MAC addresses by sending them at random times.

16. The apparatus as in claim 15, wherein the apparatus staggers the BGP MAC withdrawal messages by:
setting random timers for each of the plurality of MAC addresses; and
sending a corresponding BGP MAC withdrawal message for one of the plurality of MAC addresses on expiration of its random timer.

17. The apparatus as in claim 11, wherein the apparatus sends the BGP MAC withdrawal message to a provider edge (PE) router.

18. The apparatus as in claim 11, wherein the apparatus sets the random timer based in part on an Ethernet Segment Identifier associated with the MAC address being active.

19. The apparatus as in claim 11, wherein the Ethernet Segment is one of a plurality of all-active, multi-homed EVPN Ethernet Segments associated with the apparatus.

20. A tangible, non-transitory, computer-readable medium storing program instructions that cause a device to execute a process comprising:
making, by the device, a determination that an interface associated with an Ethernet Segment of an Ethernet Virtual Private Network (EVPN) has failed;
clearing, by the device and based on the determination, a Media Access Control (MAC) address associated with the Ethernet Segment from a Layer-2 Routing Information Base (L2RIB) of the device;
setting, by the device, a random timer for the MAC address; and
sending, by the device, a Border Gateway Protocol (BGP) MAC withdrawal message for the MAC address on expiration of the random timer.
